(19) United States
(12) Patent Application Publication
(10) Pub. No.: US 2006/0004591 A1
(43) Pub. Date: Jan. 5, 2006

(54) Web-based electronic export-import compliance and licensing processing system

(76) Inventors: Joel A. Johnson, Oak Hill, VA (US); Andrei Balotescu, San Mateo, CA (US); Alan B. Fine, Lafayette Hill, PA (US); Gregory J. Gautier, Montgomery, TX (US); Bruce L. Gibbard, Wayne, PA (US); Thien-Truc C. Nguyen, Germantown, MD (US); Eric S. VanWinkle, Purcellville, VA (US)

Correspondence Address: DUANE MORRIS LLP, PO BOX 5203, PRINCETON, NJ, 08543-5203, US

(21) Appl. No.: 10/884,515

(22) Filed: Jul. 2, 2004

(51) Int. Cl. G06F 17/60

(52) U.S. Cl. 705/1

(57) ABSTRACT

An ECLPS export/import license and request control program includes a module which allows the ultimate user to initiate the request in a controlled manner, with archiving of the original request.

### FIELD OF THE INVENTION

This invention relates to computer-based processing systems for facilitation of control of the process of seeking and complying with the restrictions associated with export/import licenses.

### BACKGROUND OF THE INVENTION

The United States Government maintains many rules and regulations which affect trade by United States Persons, which includes both such as individuals and corporations. These rules and regulations are administered by the Bureau of Industry and Security of the United States Department of Commerce, the Directorate of Defense Trade Controls of the United States Department of State, the Defense Technology Security Administration, the military services and agencies of the Department of Defense (DOD), the Bureau of Alcohol, Tobacco, and Firearms of the United States Department of Justice, the Office of Foreign Assets Control (OFAC) of the United State Department of Treasury, and the U.S. Customs and Boarder Protection of the United States Department of Homeland Security, and other governmental agencies. The International Traffic in Arms Regulations (ITAR) and Export Administration Regulations (EAR) are among the regulations, which must be adhered to. The complexity and number of the regulations and administrative agencies makes compliance difficult and time-consuming.

The Directorate of Defense Trade Controls (DDTC) of the Department of State developed and has distributed an electronic license application transmittal and archiving function known as the Electronic License Entry System (ELLIE). Ellie allows the user to electronically transfer the data that is displayed on the license application and subsequently the official approved license. However, the ELLIE system does not offer the ability to electronically transmit the associated backup documentation that is required by the ITAR. The result is a system in which the license requestor transmits the license data electronically via ELLIE and subsequently provides the backup documentation in hardcopy to DDTC. A drawback to the ELLIE system is that the license requestor cannot save drafts prior to submission, copy previous submissions to save time, or keep a database of the parties of the information relating to the license to aid in compliance. The data must be manually typed and transmitted in full at the time of entry.

FIG. 1 is a simplified block diagram of a prior-art web-based computerized system or application known as the Export-Import Compliance & Licensing Processing System (ECLPS) generated for Lockheed Martin Corporation. In FIG. 1, the ECLPS application 10 involves at least three different offices. The offices include a corporate export/import office 12, which in the ECLPS embodiment would be the main Lockheed Martin Corporation export/import office. The corporate export/import office receives export/import license requests from the export control office of any of a large number of business units of the corporation. In FIG. 1, one of the many business units is designated 14. The corporate export/import office 12 of FIG. 1 performs a review of the completeness and adherence to standards of the electronic license requests which it receives from the business unit 14, as suggested by the CEIO Review decision block 20 of corporate export/import office 12. More particularly, if the review represented by decision block 20 results in non-approval of the electronic export/import license application, represented by the NO output of the decision block, the electronic application is returned to the export control office 14 of the business unit by a path represented as 22. On the other hand, the review represented by decision block 20 of FIG. 1 may result in approval of the electronic export/import license application, meaning that all requirements for approval of the license have been fulfilled, including entry of all information and conformance with all applicable standards. If the electronic application is approved by the CEIO review decision block 20, the process flows by way of the YES output of decision block 20 to a further block 24, which represents the submission of the electronic license application to the U.S. Government and the archiving in a block 26 of the application so submitted.

If each of the many business units of the corporate entity were to individually file its own export/import license requests with the United States Government, the quality of the licenses might vary, and important issues might be missed by some business units which had little experience in relation to particular types of licenses. Thus, an electronic export/import license request as produced by Generate License Application block 34 of business unit 14 may be incomplete or may fail to meet some standards. The review of export/import licenses performed by the corporate export/import control office 12 of FIG. 1 has the advantage of allowing a central office to perform a final review of all licenses which are submitted to the government, and to review the license applications for compliance with some standards of which only the corporate office might be aware. Such assurance of the quality of the applications, in turn, tends to speed issuance of the license by the applicable governmental units. Also, it assures that the corporation has performed due diligence in complying with US Government requirements.

In FIG. 1, the electronic export/import license applications are received, docketed and staffed (distributed to the appropriate agency) by a governmental agency, as suggested by block 30. Eventually, some action is taken on the license application, and electronic application goes to final action illustrated as a block 32. When a decision is made as to allowing or rejecting the license request, the allowed license, possibly including provisos, or the rejection information are transmitted to the corporate export/import office 12, as suggested by path 34. The license information, if approved, is transmitted to the business unit export control office for permitting export or import. In the case of a rejection of the license, further action is taken to generate a more compliant license request.

Improved or alternative electronic preparation and review of export/import license applications is desired.

### SUMMARY OF THE INVENTION

A method for Export-Import Compliance and License Processing includes the steps of generating, at a corporate business unit, an export/import license request, and saving an electronic copy of the export/import license request. The method includes transmitting the export/import license request to a corporate business unit licensing office. At the corporate business unit licensing office, relevant information is entered into an electronic application for a license for import or export (import/export) of ITAR-related materials. An electronic copy of the electronic license application is saved. The electronic license application is transmitted from the corporate business unit licensing office to a corporate export-import licensing office for approval, and for submission by the corporate export/import office of an approved license application to an export/import control entity within the United States Government. This control entity may be the Department of State, or it may be a Defense-related agency. The electronic license application is at least electronically reviewed for approval at the corporate export/import licensing office. The electronic review includes verifying that (a) all relevant information is entered, and (b) the electronic license application meets applicable standards. The verification of meeting applicable standards may include verifying that the electronic license application has no missing or noncompliant materials. If the electronic license application is not approved by the corporate export/import licensing office, the electronic license application is returned from the corporate export/import licensing office to the corporate business unit licensing office. The steps of entering, transmitting, reviewing, and returning are repeated until the electronic license is approved by the corporate export/import licensing office. Following the approval, the electronic license application is transmitted from the corporate export/import licensing office to the export/import control entity. According to an aspect of the invention, the step of generating an export/import license request is performed electronically to thereby generate an electronic export/import license request for transmission to the corporate business unit licensing office. According to another aspect of the invention, an electronic copy of the export/import license request is saved. As a result, the license request can be readily audited together with the license application.

### BRIEF DESCRIPTION OF THE DRAWING

FIG. 1 is a simplified functional block diagram illustrating a prior-art process for electronic processing of export/import license applications;

FIG. 2 is a simplified functional block diagram illustrating modifications made to the arrangement of FIG. 1 according to an aspect of the invention;

FIG. 3 illustrates details of a modification illustrated in FIG. 2.

### DESCRIPTION OF THE INVENTION

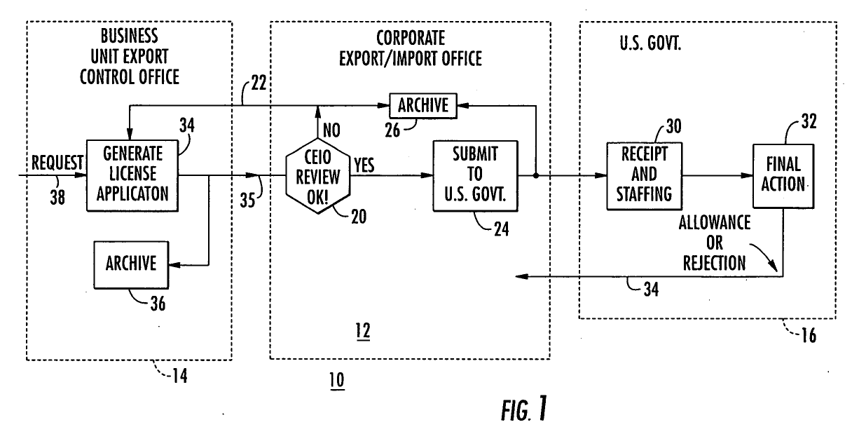

In the prior-art method described in conjunction with FIG. 1, the export/import license applications which are reviewed by the corporate export/import office 12, and either returned to the business unit 14 or forwarded to the U.S. Government 16, can be readily audited and reviewed by virtue of immutable storage in archive 26. Similarly, the export/import license applications prepared by the business unit export control office 14 can also be reviewed and audited by virtue of storage in an archive 36 of the application as forwarded to the corporate export/import office. It has been found, however, that errors or problems can enter the system concurrently with the request for the license, which as represented in FIG. 1 by path 38, comes from without the export control office 14 of the associated business unit.

The errors or problems arise from incomplete, improper, or misleading information accompanying the license request arriving by way of path 38 of FIG. 1. It may occur that the license request communicated to the export control office of the business unit is oral. In that case, there is no possibility of auditing the license application back to the time it was a license request. If the license request is in written form, it is often not found in an electronic system, but is instead a letter of request, or possibly a filled-out hard-copy form. When the license request is in paper form, it may exist at the time the audit is performed, but be difficult to locate. Whether the export/import license request is or is not written, the auditing is difficult.

According to an aspect of the invention, the electronic export/import license application system described in conjunction with FIG. 1 is supplemented with a new program module which allows electronic preparation of an export/import license request by a requestor in the business unit, and provides for archiving of the request each time it is submitted to the export/import control office of the business unit.

The new program module provides the user in the business unit with various functionalities. Among the functionalities are a simple wizard which directs the user to the proper type of license request or electronic form for his particular situation, termed the document determination questionnaire. When the request is submitted, the license request is archived. The application request flowing between the business unit licensing office and the corporate export/import office is also archived. The screens presented to the license requesting user are simplified so as to request only information which is available to the user, and so as not to refer to information which is normally available to the business unit export control office. As an example of such information, the license requesting user may not know through what port the licensed matter may be shipped, while the business unit export control office will ordinarily have that information. Thus, the screens presented to the user in the additional module make no reference to the shipping port.

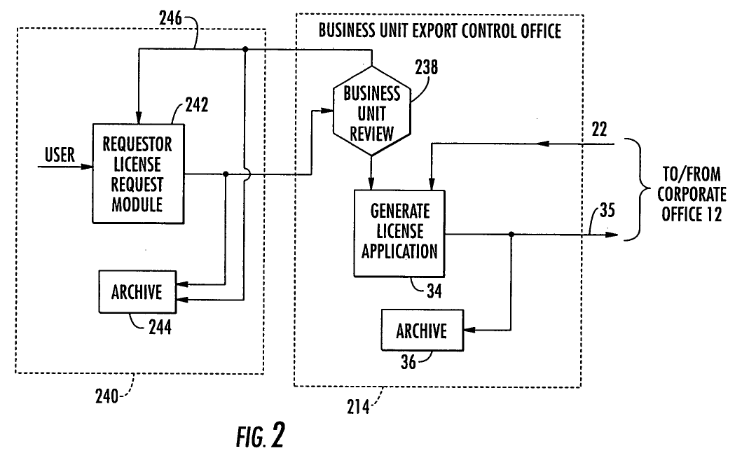

FIG. 2 is a simplified functional block diagram illustrating changes made to the arrangement of FIG. 1 according to an aspect of the invention. In FIG. 2, the Business Unit Export Control Office is designated 214 instead of 14 as in FIG. 1, to thereby indicate that it is modified from the FIG. 1 arrangement. More particularly, the request information entering by way of path 38 is electronic, and is applied to a decision process illustrated as a decision block 238. Block 238 represents an examination of the electronic license request received by way of path 38, and a decision as to whether it is compliant or non-compliant. In this context, compliant means complete and valid. This evaluation is performed at least electronically and preferably both electronically and manually. If the license request is compliant, the information is passed on to block 34 for generation of a license request. On the other hand, if the license request is noncompliant, the noncompliant status is returned electronically to the user in block 240 and to archive 244 by way of a path designated 246. The user may then correct the license request and re-submit it.

Also in FIG. 2, the additional requestor computer program module is designated 240. Module 240 is connected to the main ECLPS program by way of path 38, which, unlike the paper request path of FIG. 1, is now a network connection. Block 242 of module 240 of FIG. 2 presents various forms and choices to the person who is the ultimate user or requestor of the export/import license, performs its own checks and compliance reviews, and, when the requester program module is satisfied, allows the request to be forwarded to the business unit export control office 214. Module 240 also archives the request so forwarded, either locally in an archive 244, or in the ECLPS system as a whole.

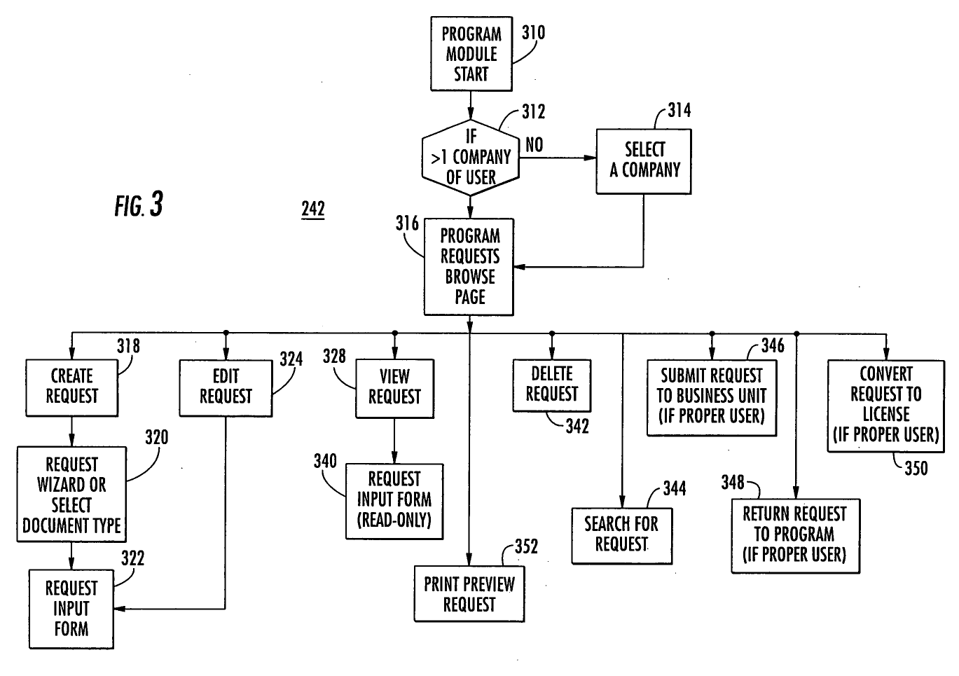

FIG. 3 is a more detailed functional block diagram of program module 242 of FIG. 2. In FIG. 3, program module 242 includes a START block 310. The logic flows from START block 310 to a decision block 312, which examines a flag to determine if the user has specified a business unit to which he and the license request “belong.” If such a specification has not been made, the logic leaves decision block 312 by the NO output, and proceeds to a block 314, which represents presentation of a screen requesting that a business unit be identified. Either from block 314 or from the YES output of decision block 312, the logic flows to a block 316, which provides a browse page with various potentially useful program requests, all for the identified business unit. Among these are Create License Request, Edit License Request, View License Request, Delete License Request, Search for License Request, Submit License Request to business unit Export/Import Office, Return Request to Program, Convert License Request, and Print Preview Request. The selected program requests are believed to cover many potentially useful actions.

The Create License Request screen 318 presents the choice for a License Request Wizard 320 or for an on-screen Request Input form or screen 322. Experienced users may be better served by a document form to be filled out on-line, while less-skilled users may find the Wizard more useful. The Request Input Form 322 includes spaces for filling in the country or countries at which the end item will ultimately be located in case of an export, purpose of the export, and also other matter which may be important to the particular business unit, such as background history information for the request, the parties or freight forwarder, consignee, and the like.

The Edit Request screen 324 allows identification of a particular license request for modification. This screen may be used when information becomes available which was not available at the time the original license request was filled out, or it may be used when the business unit export/import office has returned or rejected the request for some error or inconsistency. From block 324, the logic flows to block 322 so that the information may be amended or added.

View Request screen 328 provides for access to a read-only version of the license request. Block 328 leads to block 340, which is the read-only version of the current state of the license request. This current state may include the entire input form 322 together with a history of the license request, and also allows annexed comments to be viewed.

The Print Preview Request block 352 provides an Adobe PDF output of the license request for hardcopy archival.

The Delete Request block 342 allows for deletion of a license request that is still in the edit process. Once a license request has been submitted for review it cannot be deleted.

The Search for Request block 344 provides the ability to search the business unit's license request repository based on specific search criteria.

The Submit Request to Business Unit block 346 is the action performed when the requester has completed the request input form with all applicable data and is ready to receive the business unit licensing office review.

Upon receipt by the business unit licensing office, the reviewer can return the request to the requester 348, asking for additional clarification or information, or convert the request to a license application 350, which would then be completed and submitted to the corporate licensing office for further review and submission.

Thus, a method for Export-Import Compliance and License Processing includes the steps of generating, at a corporate business unit (14), an export/import license request, and saving (36) an electronic copy of the export/import license request. The method includes transmitting (38) the export/import license request to a corporate business unit (14) licensing office. At the corporate business unit (14) licensing office, relevant information is entered into an electronic application for a license for import or export (import/export) of ITAR-related materials. An electronic copy of the electronic license application is saved (36). The electronic license application is transmitted (35) from the corporate business unit (14) licensing office to a corporate export-import licensing office (12) for approval, and for submission by the corporate export/import licensing office (12) of an approved license application to an export/import control entity (16) within the United States Government. This control entity (16) may be the Department of State, or it may be a Defense-related agency. The electronic license application is at least electronically reviewed for approval at the corporate export/import licensing office (12). The electronic review includes verifying that (a) all relevant information is entered, and (b) the electronic license application meets applicable standards. The verification of meeting applicable standards may include verifying that the electronic license application has no missing or noncompliant materials. If the electronic license application is not approved by the corporate export/import licensing office (12), the electronic license application is returned from the corporate export/import licensing office (12) to the corporate business unit (14) licensing office. The steps of entering, transmitting, reviewing, and returning are repeated until the electronic license is approved by the corporate export/import licensing office (12). Following the approval, the electronic license application is transmitted from the corporate export/import licensing office (12) to the export/import control entity (16). According to an aspect of the invention, the step of generating an export/import license request (240) is performed electronically to thereby generate an electronic export/import license request for transmission (38) to the corporate business unit (14) licensing office. According to another aspect of the invention, an electronic copy (244) of the electronic export/import license request is saved. As a result, the license request can be readily audited together with the license application.

What is claimed is:

1. A method for Export-Import Compliance and License Processing, said method comprising the steps of:
generating, at a corporate business unit, an export/import license request, and saving an electronic copy of said export/import license request;
transmitting said export/import license request to a corporate business unit licensing office;
at said corporate business unit licensing office, entering relevant information into an electronic application for a license for import/export of ITAR-related materials, and saving an electronic copy of said electronic license application;
transmitting said electronic license application from said corporate business unit licensing office to a corporate export-import licensing office for approval, and for submission by said corporate export/import office of an approved license application to an export/import control entity within the United States Government;
at said corporate export/import licensing office, electronically reviewing said electronic license application for approval, by verifying that (a) all relevant information is entered, and (b) said electronic license application meets applicable standards;
if said electronic license application is not approved by said corporate export/import licensing office, returning said electronic license application from said corporate export/import licensing office to said corporate business unit licensing office;
repeating said steps of entering, transmitting, reviewing, and returning until said electronic license is approved by said corporate export/import licensing office, and following said approval, transmitting said electronic license application from said corporate export/import licensing office to said export/import control entity;
whereby said license application can be audited;
wherein said step of generating an export/import license request is performed electronically to thereby generate an electronic export/import license request for transmission to said corporate business unit licensing office; and
saving an electronic copy of said export/import license request, whereby said license request can also be audited.

2. A method according to claim 1, wherein said step of transmitting said electronic license application from said corporate business unit licensing office to a corporate export-import licensing office for approval, and for submission by said corporate export/import office of an approved license application to an export/import control entity within the United States Government includes the step of transmitting said electronic license application from said corporate business unit licensing office to a corporate export-import licensing office for approval, and for submission by said corporate export/import office of an approved license application to an export/import control entity within the United States Department of State.

3. A method according to claim 1, wherein said step of at said corporate export/import licensing office, electronically reviewing said electronic license application for approval, by verifying that (a) all relevant information is entered, and (b) said electronic license application meets applicable standards includes the step of at said corporate export/import licensing office, electronically reviewing said electronic license application for approval, by verifying that (a) all relevant information is entered, and (b) said electronic license application has no missing or noncompliant materials.
